(19) United States
(12) Patent Application Publication
(10) Pub. No.: US 2025/0346172 A1
(43) Pub. Date: Nov. 13, 2025

(54) VEHICLE WITH EXTENDABLE CHASSIS

(71) Applicant: American Honda Motor Co., Inc., Torrance, CA (US)

(72) Inventors: JAMIE DAVIES, HUNTINGTON BEACH, CA (US); DEVON J FUJIOKA, LOS ANGELES, CA (US)

(21) Appl. No.: 18/658,776

(22) Filed: May 8, 2024

(51) Int. Cl. B60P 1/64; B60L 1/00; B60L 53/80; B60P 7/10; B62D 21/14; B62D 33/02

(52) U.S. Cl. CPC B60P 1/6481; B60L 1/003; B60L 53/80; B60P 7/10; B62D 21/14; B62D 33/02

(57) ABSTRACT

The present disclosure relates to an electric vehicle having one or more rear wheels and one or more front wheels, a motor for rotating the one or more rear wheels, an energy source powering the motor, a pedal in combination with the motor for assisting in rotating the one or more rear wheels, a rear chassis configured to carry a plurality of cargo boxes, and a chassis motor coupled to the rear chassis for extending and retracting the rear chassis, wherein electrical wiring runs from the energy source and through the rear chassis to power the chassis motor. The rear chassis may be set up in multiple configurations for the electric vehicle to transport cargo boxes and containers.

### TECHNICAL FIELD

The present disclosure relates to an electrically powered, pedal-assisted vehicle with an extendable chassis. The extendable chassis may provide multiple configurations for the vehicle to transport cargo boxes and containers.

### BACKGROUND

Electric powered vehicles are becoming increasingly popular in city environments and rural landscapes. Particularly in highly populated regions, electric vehicles remove the need for drivers to fill up at gas stations. However, electric vehicles in a city are typically constrained to the same limitations as gas-powered vehicles in terms of where they may drive. This, in turn, becomes problematic for drivers needing to perform efficient cargo deliveries with their vehicle because they are limited to driving only on city roads, just like gas-powered vehicles. For these reasons, smaller, compact electric vehicles also fail to provide more mobility than gas-powered vehicles. During high levels of traffic, both electric and gas vehicle drivers may endure long wait times while in the same lines.

An alternative to electric vehicles is electric powered bikes, which are smaller and more compact, and able to utilize either streets or bike lanes to navigate around and through traffic, thus improving the mobility of a rider in a city. Pedal-assisted electric powered bikes are especially convenient for riders making long commutes for package deliveries. However, just like electric vehicles, electric bikes are also limited in capabilities for riders. For instance, electric bikes are constrained by how much cargo they may load, how much power they may provide based on battery size that is limited by bike form factors, and how much protection may be provided to a rider (e.g., from weather, other riders, cars, external dangers, etc.). Electric bikes are often not readily configurable upon purchase, leaving responsibility to a rider to adapt bicycles to their needs.

Accordingly, it would be advantageous to provide an electrically powered vehicle with an extendable chassis that allows a maximum cargo load of a vehicle to be configured, that covers a driver, and that is compact enough to be driven in bicycle lanes. Such a vehicle would provide regulatory adaptability for different markets or changing regulations.

### SUMMARY

In accordance with one embodiment, a vehicle is provided that includes one or more rear wheels and one or more front wheels, a motor for rotating the one or more rear wheels, an energy source powering the motor, a pedal in combination with the motor for assisting in rotating the one or more rear wheels, a rear chassis configured to carry a plurality of cargo boxes, and a chassis motor coupled to the rear chassis for extending and retracting the rear chassis, wherein electrical wiring runs from the energy source and through the rear chassis to power the chassis motor.

In accordance with another embodiment, a method for transporting a plurality of cargo boxes through an electrically powered vehicle is provided. The method may include providing electrical power from an energy source of the vehicle to a chassis motor of the vehicle through electrical wiring that runs through a rear chassis of the vehicle and couples the chassis motor to the energy source of the vehicle, extending the rear chassis from a retracted configuration to an extended configuration by the chassis motor, wherein the chassis motor is further coupled to an extendable portion of the rear chassis, and locking a first number of the plurality of cargo boxes onto the rear chassis with respective locking mechanisms located on the rear chassis.

In accordance with another embodiment, a cargo transportation system of an electrically powered vehicle is provided. The vehicle may include one or more rear wheels and one or more front wheels, an energy source mounted near or between the one or more front wheels and configured to power a motor that rotates the one or more rear wheels, a pedal in combination with the motor for assisting in rotating the one or more rear wheels, a rear chassis configured to carry a plurality of cargo boxes that is extendable past the one or more rear wheels, and a chassis motor coupled to the rear chassis for extending and retracting the rear chassis, wherein electrical wiring runs from the energy source and through the rear chassis to power the chassis motor.

### BRIEF DESCRIPTION OF THE DRAWINGS

FIG. 1 is a partial see-through side view of an exemplary electric vehicle in a retracted configuration in accordance with one aspect of the present disclosure.

FIG. 2 is a partial see-through top view of the exemplary electric vehicle in a retracted configuration in accordance with one aspect of the present disclosure.

FIG. 3 is a side view of the exemplary electric vehicle in an extended configuration in accordance with one aspect of the present disclosure.

FIG. 4 is a top view of the exemplary electric vehicle in an extended configuration in accordance with one aspect of the present disclosure.

FIG. 5 is a partial see-through side view of the exemplary electric vehicle in an extended configuration showing a chassis motor and electrical wiring, in accordance with one aspect of the present disclosure.

FIG. 6 is a partial see-through top view of the exemplary electric vehicle in an extended configuration showing the chassis motor and electrical wiring, in accordance with one aspect of the present disclosure.

FIG. 7A is a partial see-through side view of the exemplary electric vehicle in a linearly moving configuration showing the chassis motor and electrical wiring, in accordance with one aspect of the present disclosure.

FIG. 7B is a partial see-through side view of the exemplary electric vehicle in a rotating configuration showing the chassis motor and electrical wiring, in accordance with one aspect of the present disclosure.

FIG. 8 is a partial see-through side view of the exemplary electric vehicle in a retracted configuration showing the chassis motor and electrical wiring, in accordance with one aspect of the present disclosure.

FIG. 9 is a partial see-through top view of the exemplary electric vehicle in a retracted configuration showing the chassis motor and electrical wiring, in accordance with one aspect of the present disclosure.

FIG. 10 is a top view of the exemplary electric vehicle in an extended configuration with locking mechanisms in accordance with one aspect of the present disclosure.

FIG. 11 is a flowchart for locking cargo boxes to a rear chassis and providing power to a chassis motor of the exemplary electric vehicle in accordance with one aspect of the present disclosure.

FIG. 12 is a flowchart for retracting a rear chassis with locked cargo boxes for the exemplary electric vehicle in accordance with one aspect of the present disclosure.

FIG. 13 is a flowchart for charging an energy source for the exemplary electric vehicle in accordance with one aspect of the present disclosure.

The figures depict various views of the embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In embodiments described herein, an electrically powered vehicle includes an extendable chassis that allows a maximum cargo load of a vehicle to be configured, wherein the vehicle covers a driver and is compact enough to be driven in bicycle lanes. The vehicle may provide regulatory adaptability for different markets or changing regulations. For instance, the configurability of the vehicle may allow the vehicle to adapt to regulations in various countries and/or regions of a country. Configurable features of the vehicle may include: size, wheels, number of cargo boxes to be carried, speed, electrical constraints, any other feature of a vehicle described herein, or any other feature of a vehicle.

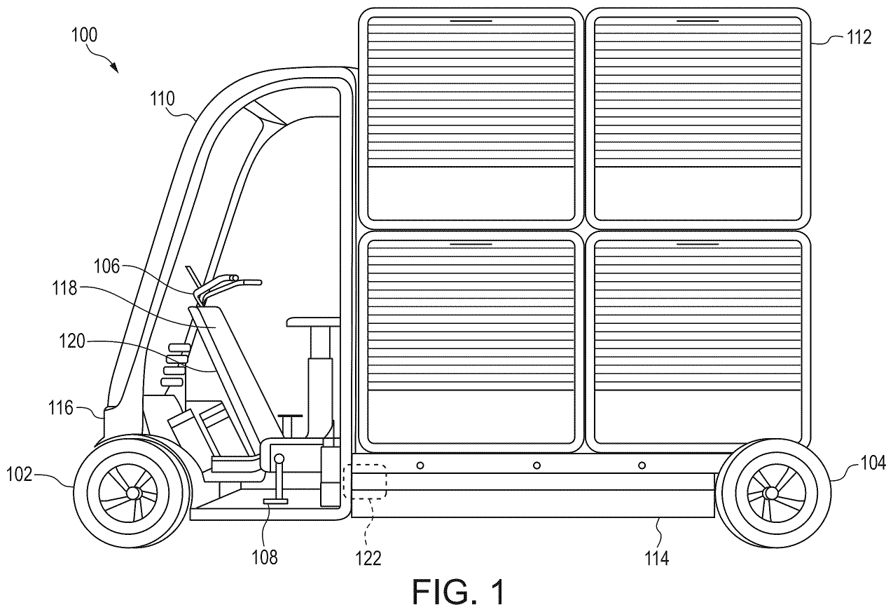

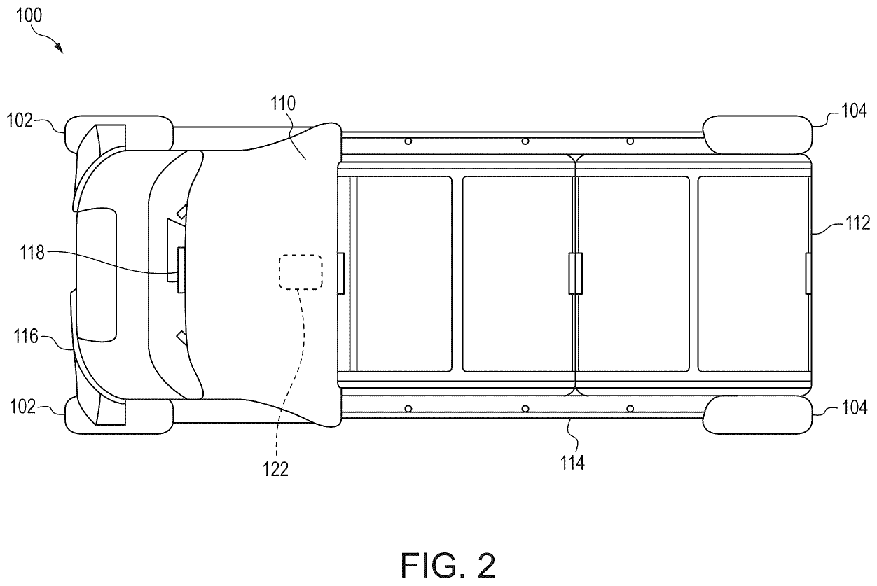

In an embodiment, FIG. 1 is a partial see-through side view of an electric vehicle 116 in a retracted configuration 100 and FIG. 2 is a partial see-through top view of electric vehicle 116 in retracted configuration 100. FIG. 1 and FIG. 2 are described in conjunction. Electric vehicle 116 may include one or more front wheels 102, one or more rear wheels 104, a steering wheel 106, pedals 108, a cabin 110, cargo boxes 112, a chassis 114, an energy source 118, a pillar 120, and a motor 122 (as shown from a top down see-through view). Front wheels 102 and rear wheels 104 may each include one or more wheels, which may be coupled to chassis 114 and located along a primary axis of chassis 114. In embodiments, steering wheel 106 may take the form of a circular wheel, a stick, a handlebar (e.g. Yolk handlebar), or any shape in which a driver of electric vehicle 116 may grip and control the direction of electric vehicle 116.

Energy source 118 may be any type of energy source for a vehicle, such as a battery, and may be oriented vertically (shown in FIG. 1) or horizontally (shown in FIG. 2) on electric vehicle 116. Energy source 118 may be located anywhere on electric vehicle 116, such as near front wheels 102 (e.g., closer to front wheels 102 than rear wheels 104), between front wheels 102 (shown in FIG. 1, e.g., between the planes of front wheels 102), and/or anywhere within cabin 110. In an embodiment, energy source 118 Energy source 118 may be contained and/or mounted on/in pillar 120. Pillar 120 may be mounted to electric vehicle 116 to structurally support steering wheel 106. In an embodiment, pillar 120 is energy source 118.

Motor 122 may be any type of motor for powering a vehicle and may be coupled to energy source 118 through electrical wiring, as described elsewhere herein. As depicted from a top view, and seeing within vehicle 116, the motor may be located within cabin 110 at a lower portion of electric vehicle 116. Motor 122 may be located anywhere on or in electric vehicle 116. Motor 122 may support the drive of one or more of: front wheels 102 and rear wheels 104. Motor 122 may convert electrical energy from energy source 118 to mechanical energy for driving the wheels of electric vehicle 116.

Pedals 108 may include one or more pedals for generating mechanical and/or electrical power, when rotated by a driver, for example, to motor 122 and/or energy source 118 (e.g., a battery) of electric vehicle 116. Pedals 108 may provide pedal assist to the driving wheels of electric vehicle 116. For example, if electric vehicle 116 is a front-wheel drive (FWD), rear-wheel drive (RWD), or all-wheel drive (AWD), pedals 108 may provide pedal assist, respectively, to front wheels 102, rear wheels 104, or both front wheels 102 and rear wheels 104. In an embodiment, electric vehicle 116 may include a mechanical mode (e.g., through a button, configuration, or user selection, etc.) in which electric vehicle 116 is powered solely by pedals 108, similar to a manual bicycle. In an electric mode, electric vehicle 116 may include a rechargeable battery, as energy source 118, that is coupled to pedals 108, similar to an electric bicycle. The rechargeable battery may also be swappable (i.e., swapped with a different battery, removeable, replaceable). For instance, if a user runs out of charge in a first battery, a second battery with a full charge may replace the first battery to continue to provide an energy source, such as energy source 118, to electric vehicle 116.

Cabin 110 may be included in electric vehicle 116 as covering and/or protection of a driver from external factors such as wind, debris, vehicles, pedestrians, etc. Cabin 110 may include features such as one or more doors and one or more windows. In an embodiment, electric vehicle 116 may not include cabin 110 or features of cabin 110 for easier driver accessibility.

Materials in which cabin 110 or other components of electric vehicle 116 may be made of include, but are not limited to: plastic (thermoplastics, polyvinyl chloride (PVC), polyethylene terephthalate (PET), high-density polyethylene (HDPE), polystyrene, etc.), metal (copper, aluminum, steel, etc.), carbon fiber, rubber, glass, silicone, and any material known to involve vehicle manufacture.

Cargo boxes 112 may include one or more cargo boxes that may be loaded onto electric vehicle 116. In embodiments, cargo boxes 112 may be utility boxes, containers, lockable boxes, mail boxes, mail containers, shipping containers, delivery packages, storage boxes, cargo carriers, luggage, freight, transport box, crates, trunks, bins, or any other type of container for carrying items or materials. Cargo boxes 112 may include box locks to prevent contents inside cargo boxes 112 from being easily accessed from the outside, while electric vehicle 110 is being driven, for example. Cargo boxes 112 may be any size and may be stacked on chassis 114 and/or to each other.

Cargo boxes 112 may be made of, but are not limited to, the following materials: plastic (thermoplastics, polyvinyl chloride (PVC), polyethylene terephthalate (PET), high-density polyethylene (HDPE), polystyrene, etc.), metal (copper, aluminum, steel, etc.), carbon fiber, rubber, glass, silicone, and any material known to involve cargo box manufacture.

A locking mechanism may be included on each of cargo boxes 112 and on chassis 114 for locking cargo boxes 112 to each other or to chassis 114. The locking mechanism may lock cargo boxes 112 together or may lock cargo boxes 112 to chassis 114, or both. The locking mechanism may be of any type, or combination of types, examples of which may include padlocks, deadbolts, cam locks, pin tumbler locks, combination locks, electronic locks, magnetic locks, lever handle locks, interlocking mechanisms, toggle clamps, latch mechanisms, safety locks, etc. Furthermore, the locking mechanism may be orientation-dependent, in which cargo boxes 112 may require a specific orientation in order to lock a locking mechanism.

Chassis 114 or any other chassis of electric vehicle 116 may structurally support all features and additions of electric vehicle 116, which may be coupled (e.g., mechanically) to chassis 114, for example. Chassis 114 or any other chassis of electric vehicle 116 may be of any material, structure, design, or combination thereof, examples of which may include body-on frame, monocoque or unibody, spaceframe, backbone, tubular, spaceframe monocoque hybrid, integral chassis, ladder frame, hybrid chassis, etc. Chassis 114 may be the base frame or a structure framework for electric vehicle 116. Chassis 114 may be a fixed platform and/or a fixed flatbed that is fixed with respect to electric vehicle 116.

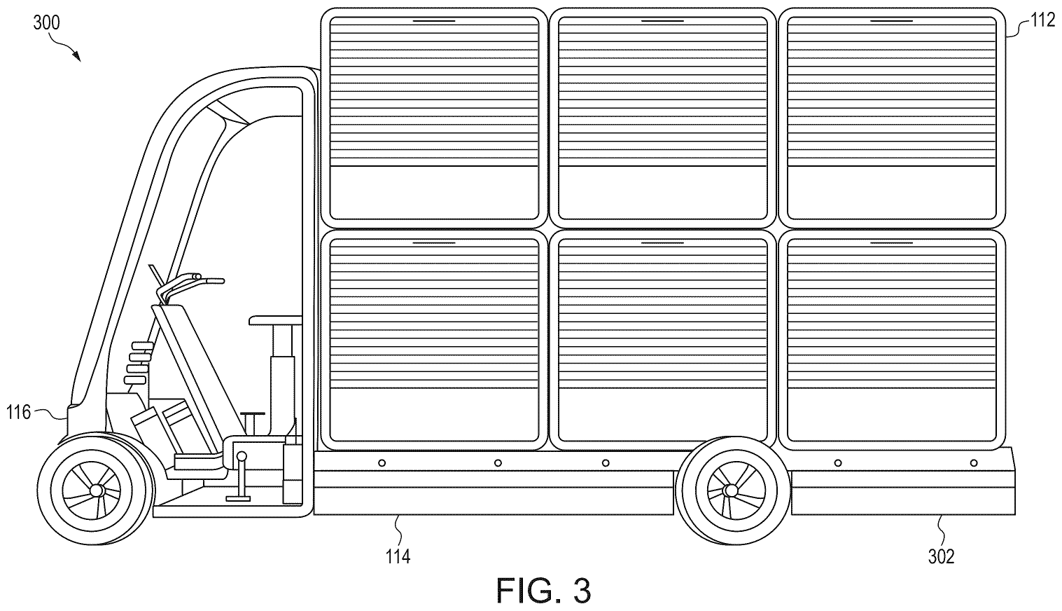

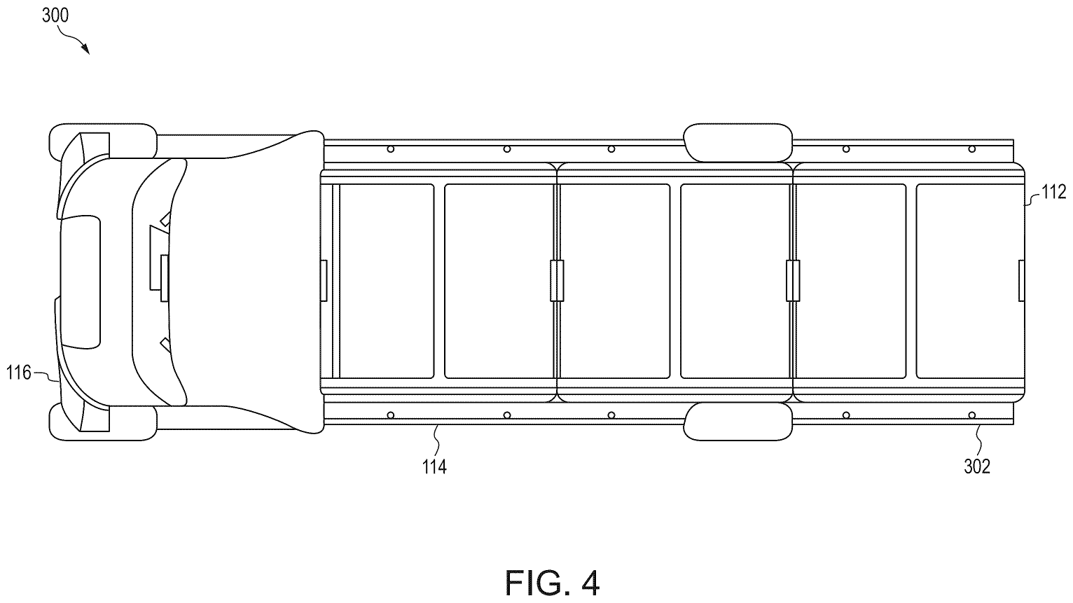

In a further embodiment, FIG. 3 is a side view of electric vehicle 116 in an extended configuration 300 and FIG. 4 is a top view of electric vehicle 116 in extended configuration 300, in accordance with one aspect of the present disclosure. FIG. 3 and FIG. 4 are described in conjunction. Electric vehicle 116 may be configured between retracted configuration 100 of FIG. 2 and FIG. 3 and extended configuration 300 of FIG. 3 and FIG. 4. Extended configuration 300 may include an extendable chassis 302, as shown. Extendable chassis 302 may be of the same type(s) or different type(s) of chassis 114 and may extend out from chassis 114 to enable more capacity to store/carry cargo boxes 112. Extendable chassis 302 may include one or more motorized platforms and/or motorized flatbeds that are driven by a chassis motor. Furthermore, extendable chassis 302 and chassis 114 may be included as part of an extendable rear chassis system, which may include other vehicle components as well.

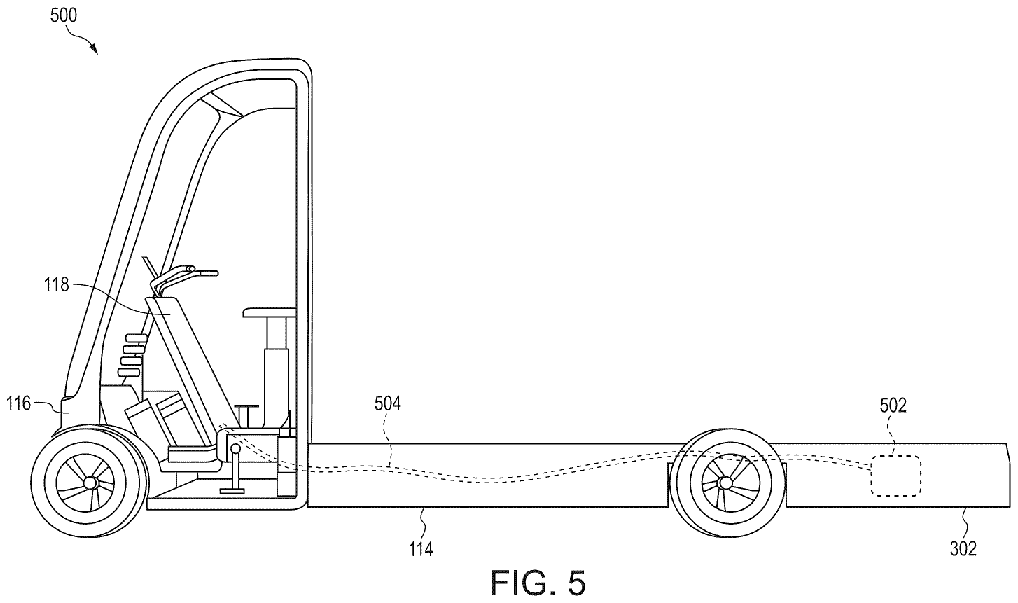

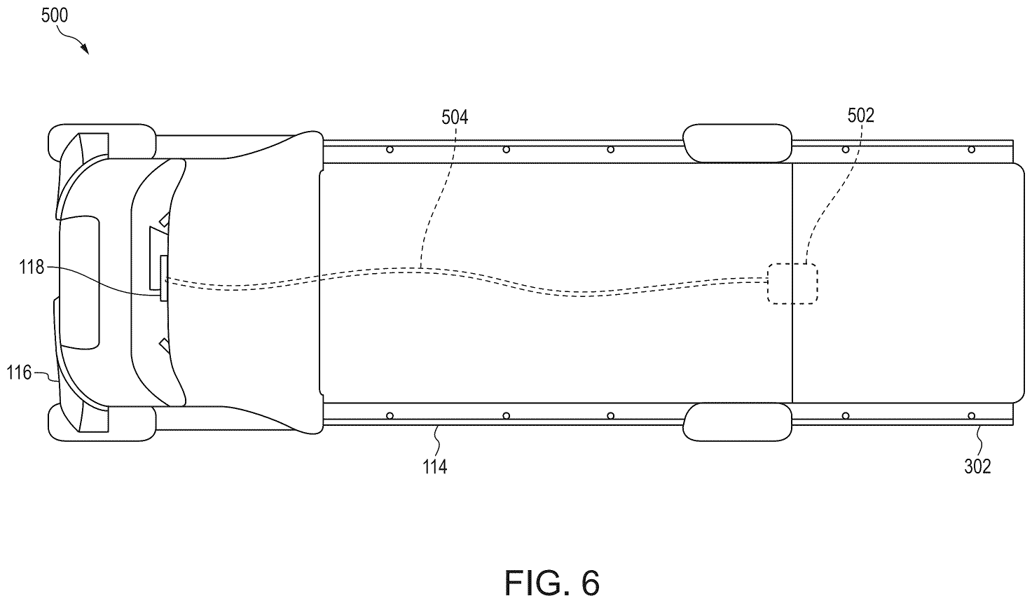

In a further embodiment, FIG. 5 is a partial see-through side view of electric vehicle 116 in an extended configuration 500, showing a chassis motor 502 (see-through view) and electrical wiring 504 (see-through view), and FIG. 6 is a partial see-through top view of electric vehicle 116 in extended configuration 500, in accordance with one aspect of the present disclosure. FIG. 5 and FIG. 6 are described in conjunction. FIG. 5 and FIG. 6 depict extended configuration 500, an alternative embodiment of extended configuration 300, in which electric vehicle 116 includes a chassis motor 502 and electrical wiring 504. Chassis motor 502 may be of any type of motor and electrical wiring 504 may be of any type of electrical wiring for extending extendable chassis 302. Chassis motor 502 and electrical wiring 504 may move with respect to chassis 114 according to various embodiments. Electrical wiring 504 is not necessarily constrained to chassis 114 but may move according to the movement of extendable chassis 302.

Chassis motor 502 may be activated electrically through/by electrical wiring 504, which may be coupled to energy source 118 of electrical vehicle 116. Energy source 118 of electrical vehicle 116 may be controlled by computer logic in the vehicle. Electrical wiring 504 may run through chassis 114 and/or extendable chassis 302. For instance, electrical wiring 504 may be located inside a chassis, on a chassis, under a chassis, around a chassis, etc. for reaching chassis motor 502 from energy source 118 and for reaching motorized portions of any chassis. Chassis motor 502 and electrical wiring 504 may be mounted anywhere in, on, or around electric vehicle 116 and are not limited in location to the embodiments described herein or by FIG. 5 and FIG. 6.

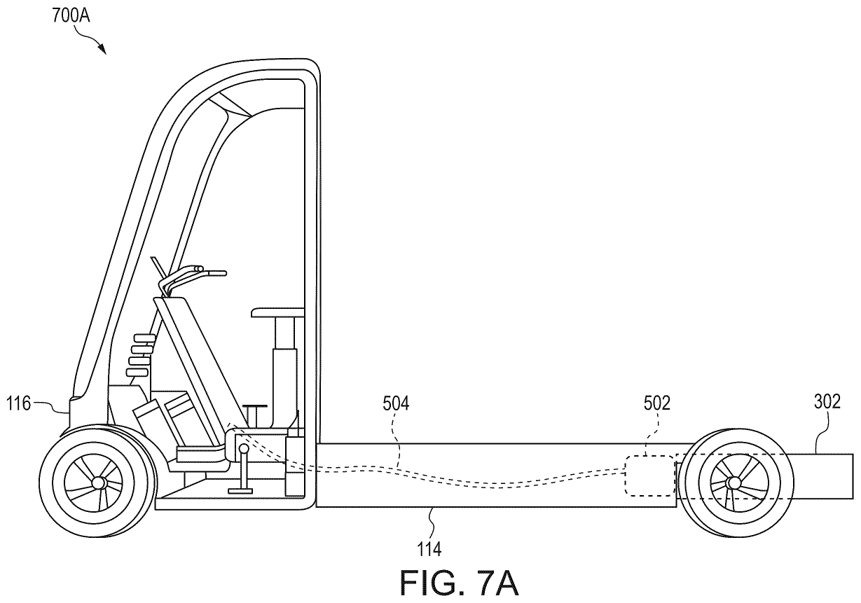

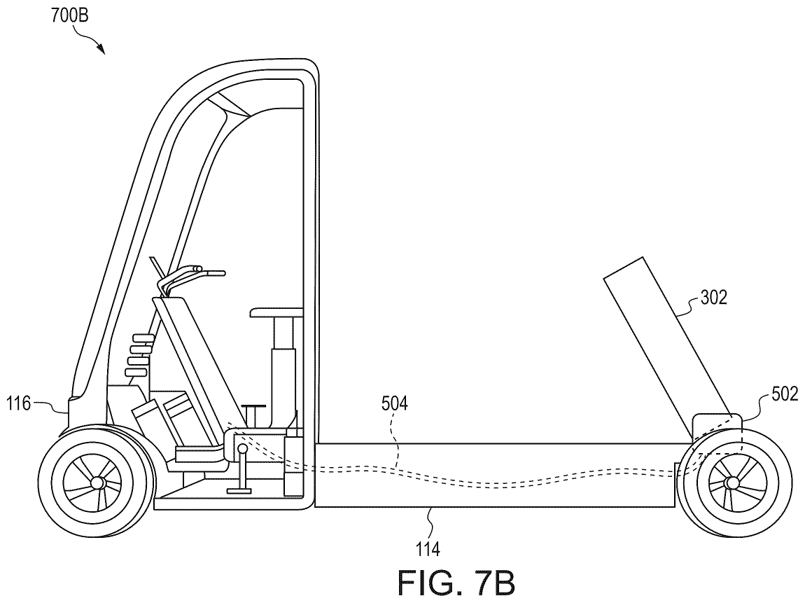

There is a plurality of methods in which extendable chassis 302 may extend from chassis 114. In embodiments, extendable chassis 302 may be a motorized chassis and/or motorized flatbed, coupled to chassis motor 502 configured to extend extendable chassis 302 from chassis 114. For example, chassis motor 502 may cause extendable chassis 302 to extend along a same or parallel plane from chassis 114, as depicted in FIG. 7A, which is a partial see-through side view of electric vehicle 116 in a linearly moving configuration 700A, showing chassis motor 502 (see-through view) and electrical wiring 504 (see-through view), in accordance with one aspect of the present disclosure. FIG. 7A depicts linearly moving configuration 700A, which is an embodiment of an intermediate configuration between retracted configuration 100 and extended configuration 300. In particular, chassis motor 502 may cause extendable chassis 302 (and components therein, i.e., electrical wiring 504) to move linearly between and parallel to the retracted and extended configurations.

In an alternative example, chassis motor 502 may extend multiple portions (e.g., one or more platforms or flatbeds) of extendable chassis 302 linearly along a same or parallel plane from chassis 114. For instance, each portion of a plurality of portions of extendable chassis 302 may be stacked on, below, or inside each other while in retracted configuration 100. Chassis motor 502 may extend one or more portions from retracted configuration 100 to extended configuration 300 and/or retract the one or more portions from extended configuration 300 to retracted configuration 100. Such moveable portions of extendable chassis 302 may represent steps or stacks of platforms that mechanically move linearly between configurations.

In another example, chassis motor 502 may extend extendable chassis 302 by causing extendable chassis 302 to rotate out from chassis 114 about a rotating axis. For instance, FIG. 7B depicts a partial see-through side view of electric vehicle 116 in a rotating configuration 700B, showing chassis motor 502 (partial see-through view) and electrical wiring 504 (see-through view), in accordance with one aspect of the present disclosure. Rotating configuration 700B is an embodiment of an intermediate configuration between retracted configuration 100 and extended configuration 300. In particular, chassis motor 502 may cause extendable chassis 302 (and components therein, i.e., electrical wiring 504) to rotate between the retracted and extended configurations.

In an alternative embodiment, extendable chassis 302 may be an extension attachment piece or part that may be manually attached (e.g., by hand) to chassis 114. For example, extendable chassis 302 may be attached to or detached from chassis 114 by a user of electric vehicle 116. Thus, electric vehicle 116 may be driven and/or pedaled with extendable chassis 302 installed or uninstalled by a user. In this embodiment, extendable chassis 302 may be a piece or a part (e.g., a flatbed extension) of electric vehicle 116, serving as an attachment to extend chassis 114, provided that extendable chassis 302 is installed/attached to chassis 114. Such installation/attachment may occur through a lock mechanism, as described elsewhere herein.

In an embodiment, chassis motor 502 may be activated, or initiate to activate, automatically by electric vehicle 116. Alternatively, chassis motor 502 may be activated, or initiate to active, by a user selection or input signal, such as a button, command, setting, configuration, etc. The user selection or input signal may be received by the vehicle directly, based on a function physically present on or inside the vehicle. Alternatively, the user selection or input signal may be received by the vehicle indirectly, based on a network (e.g., wireless network, LAN, WAN) or an electronic device (e.g., cell phone, PDA, computer, laptop, remote control, etc.). An application on such devices may receive the user selection or input and send a signal to electric vehicle 116 (e.g., CPU or other vehicle electronic function) to activate or initiate chassis motor 502.

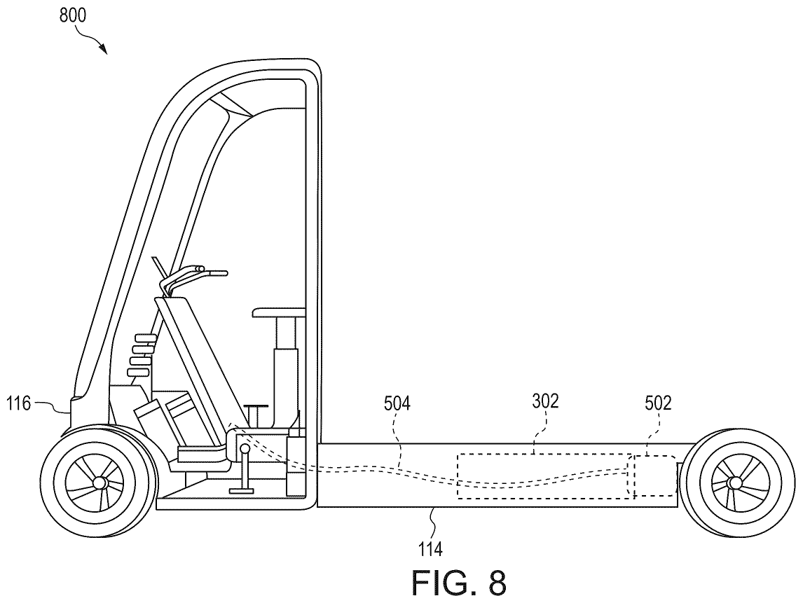

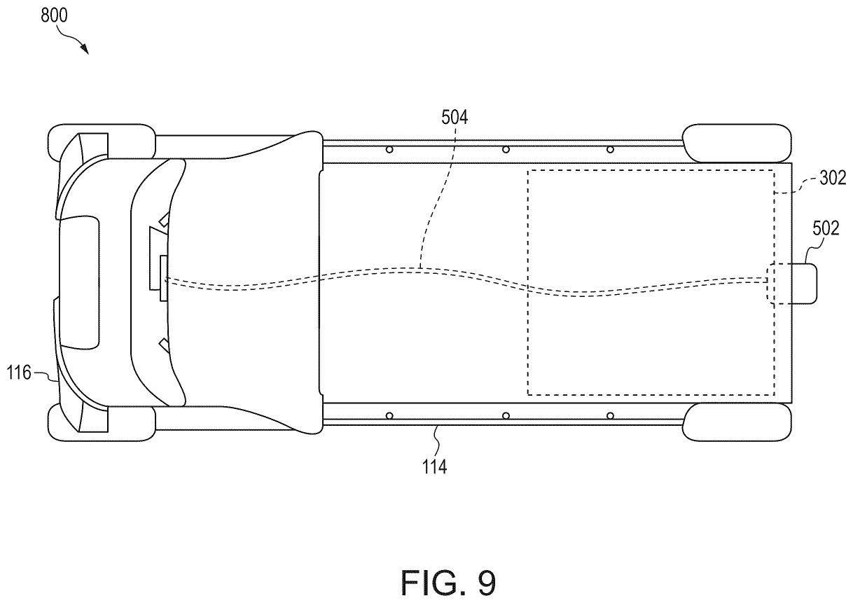

In a further embodiment, FIG. 8 is a partial see-through side view of electric vehicle 116 in a retracted configuration 800, showing chassis motor 502 (partial/see-through view) and electrical wiring 504 (see-through view), and FIG. 9 is a partial see-through top view of electric vehicle 116 in retracted configuration 800, in accordance with one aspect of the present disclosure. FIG. 8 and FIG. 9 are described in conjunction. FIG. 8 and FIG. 9 depict retracted configuration 800, an alternate embodiment of retracted configuration 100, in which chassis motor 502 and electrical wiring 504 are included. Extendable chassis 302, chassis motor 502, and electrical wiring 504, in an embodiment, are depicted in FIG. 8 and FIG. 9 as see-through views. It is noted that in any vehicle configuration, extendable chassis 302, chassis motor 502, electrical wiring 504, and any other component of electric vehicle 116 may be fully visible, partially visible, or hidden from external view. It is further noted that regardless of chassis motor type, extendable chassis 302 may be stored on top of, inside of, or below chassis 114 while in retracted configuration 100 or retracted configuration 800. Extendable chassis 302 may be attached to a coupling mechanism (e.g., chassis motor 502) while in retracted configuration 800 (e.g., instances in which extendable chassis 302 is a motorized flatbed, as described elsewhere herein). Alternatively, extendable chassis 302 may not be attached to a coupling mechanism (e.g. chassis motor 502) while in retracted configuration 800 (e.g., instances in which extendable chassis 302 is a flatbed extension, as described elsewhere herein). Electrical wiring 504 may retract according to the retraction of extendable chassis 302.

In an embodiment, chassis 114 may include storage space (e.g., a compartment), internal to chassis 114, for storing extendable portions of chassis 114 or extendable chassis 302. In an embodiment, chassis 114 is the compartment itself. Thus, a chassis of electric vehicle 116, in its entirety, may include one or both of a fixed chassis (e.g., fixed flatbed, chassis 114) and an extendable chassis (e.g., motorized flatbed, extendable chassis 302). It is noted that extendable chassis 302 and any other components are not limited in size or shape based on the figures described herein.

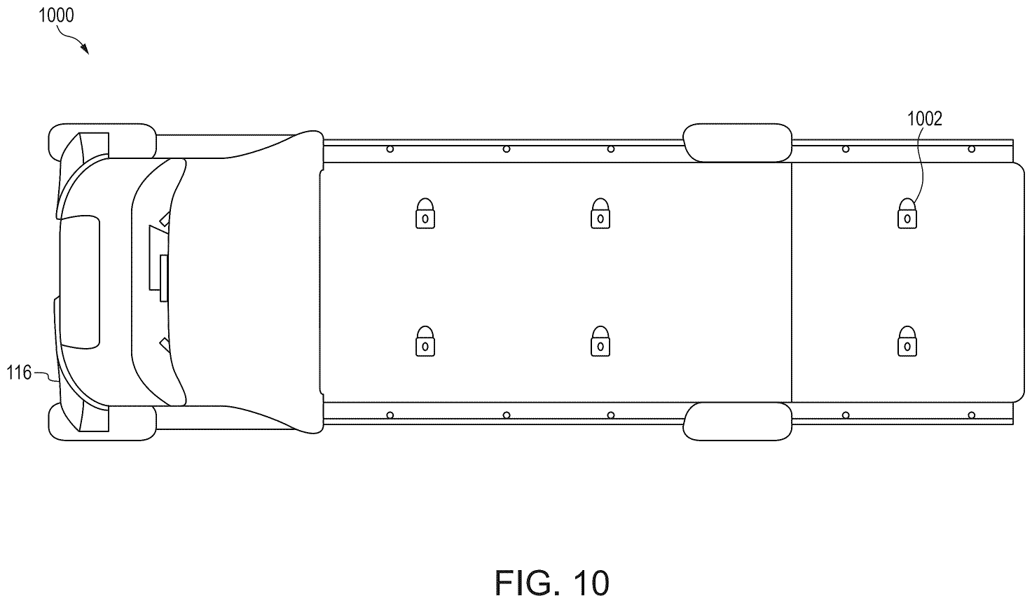

In a further embodiment, FIG. 10 is a top view of electric vehicle 116 in an extended configuration 1000, with locking mechanisms 1002, in accordance with one aspect of the present disclosure. FIG. 10 depicts extended configuration 1000, an alternate embodiment of extended configuration 300, in which one or more locking mechanisms, shown schematically at 1002, are mounted onto electric vehicle 116. Locking mechanisms 1002 may be the same or different type as those of cargo boxes 112, described elsewhere herein, and located anywhere on electric vehicle 116 for locking cargo boxes 112. Locking mechanisms 1002 may be locked to cargo boxes 112 manually or through a network.

A user selection or input signal received by electric vehicle 116 may cause locking mechanisms 1002 on electric vehicle 116 to activate, deactivate, engage, disengage, lock, unlock, or initiate lock/unlock. For example, a user with a cellphone connected to a first network may access an application on the cellphone to control locking mechanisms 1002 on electric vehicle 116. Electric vehicle 116 may also be connected to the first network (or a second, third, etc. network connected to the first network). The user may select an option in the application to disengage locking mechanisms 1002 on electric vehicle 116 to release all cargo boxes 112 that may be locked. The selection by the user is received by the cellphone and a signal is sent through the first network. Electric vehicle 116 receives the signal, which is information that user selected to disengage locking mechanisms 1002. In response to receiving the signal, electric vehicle 116 unlocks locking mechanisms 1002.

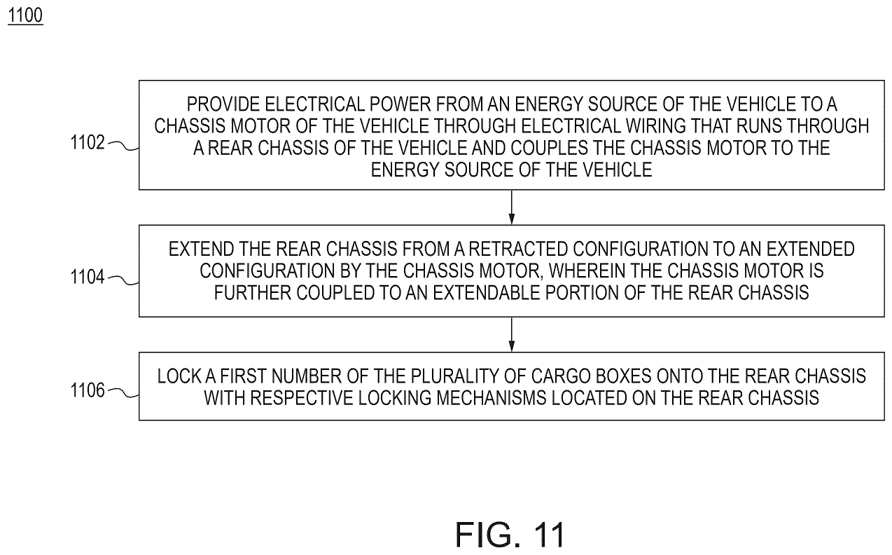

FIG. 11 depicts a flowchart 1100 for locking cargo boxes to a rear chassis (e.g., an extendable rear chassis) and providing power to chassis motor 502 of electric vehicle 116, in an embodiment. The blocks of flowchart 1100 may be performed by a vehicle, such as electric vehicle 116. Flowchart 1100 begins with block 1102, in which electrical power is provided from an energy source (e.g. energy source 118) to a chassis motor (e.g., chassis motor 502) of a vehicle (e.g., electric vehicle 116) through electrical wiring (e.g., electrical wiring 504) that runs through the rear chassis of the vehicle and couples the chassis motor to the energy source. In an embodiment, energy source 118 in combination with pedal assist from pedals 108 rotate rear wheels 104 of electric vehicle 116 to generate and provide the electrical power. Furthermore, electric vehicle 116 may provide electric power to chassis motor 502 through electrical wiring 504, from energy source 118 (e.g., a battery) and/or pedal assist functionality of pedals 108, which power the rotation of rear wheels 104.

Block 1104, subsequent to block 1102, of flowchart 1100 describes extending the rear chassis from a retracted configuration to an extended configuration by the chassis motor, wherein the chassis motor is further coupled to an extendable portion of the rear chassis. In an embodiment, electric vehicle 116 extends the extendable portion of the rear chassis (e.g., extendable portion 302) to the extended configuration (e.g., extended configuration 300). Electric vehicle 116 may be in retracted configuration 100 prior to the extension of extendable portion 302 and may be in the extended configuration 300 after extension of extendable portion 302. More specifically, electric vehicle 116 may extend the rear chassis using chassis motor 502 coupled to motor 122 and/or energy source 118 of electric vehicle 116. As described elsewhere herein, a signal may be received by electric vehicle 116 to initiate chassis motor 502 to extend extendable portion 302.

Block 1106, subsequent to block 1104, of flowchart 1100 describes locking a first number of the plurality of cargo boxes onto the rear chassis with respective locking mechanisms located on the rear chassis. In an embodiment, electric vehicle 116 may lock cargo boxes 112 onto chassis 114 and/or extendable chassis 302. A respective locking mechanism for each of cargo boxes 112 may be attached to the cargo boxes themselves and/or to a first chassis of electric vehicle 116. In an embodiment, as described elsewhere herein, locking mechanisms 1002 may be activated to lock and unlock by electric vehicle 116, in response to receiving a signal designation from a user, such as from the vehicle or from a device. Locking mechanisms 1002 located on a chassis of electric vehicle 116 may be compatible with and/or coupled to locking mechanisms located on cargo boxes 112.

As an example, a first locking mechanism of a first cargo box may couple to a second locking mechanism of a second chassis, thus resulting in first cargo box being locked to second chassis for easier and more controlled transportation of cargo. Furthermore, the first locking mechanism of first cargo box may couple to a third locking mechanism of a second cargo box. Broadly, by example, a plurality of locking mechanisms of a plurality of cargo boxes may couple to a plurality of other locking mechanisms, on a plurality of other cargo boxes or on one or more

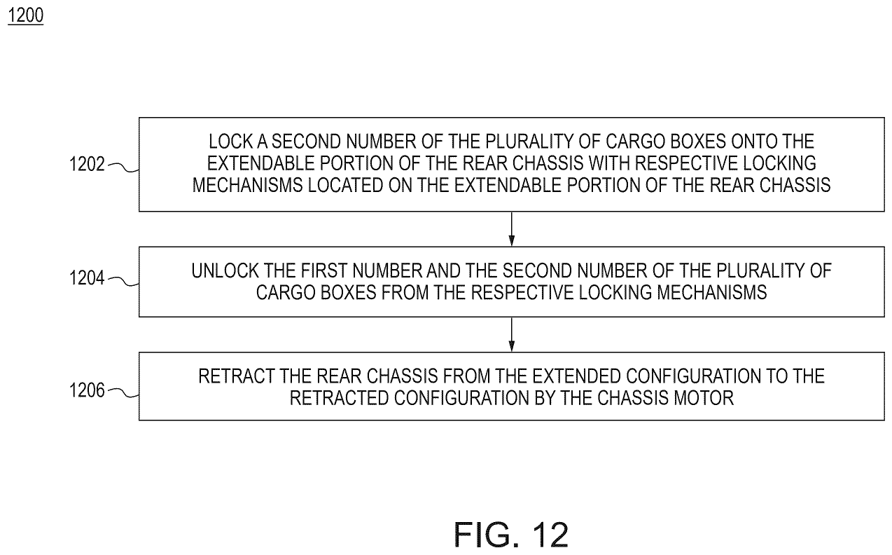

FIG. 12 depicts a flowchart 1200 for retracting a rear chassis with locked cargo boxes, in an embodiment. The blocks of flowchart 1200 may be performed by a vehicle, such as an electric vehicle, and may follow one or more of the blocks in flowchart 1100. Flowchart 1200 begins with block 1202, in which a second number of the plurality of cargo boxes are locked onto the extendable portion of the rear chassis with respective locking mechanisms located on the extendable portion of the rear chassis. In an embodiment, electric vehicle 116 locks the second number of the plurality of cargo boxes (e.g., cargo boxes 112) onto the extendable portion of the rear chassis (e.g., extendable chassis 302) with/using locking mechanisms 1002. It is noted that block 1106 and block 1202 may lock by a same or different method.

In block 1204, subsequent to block 1202, the first number and the second number of the plurality of cargo boxes are unlocked from the respective locking mechanisms. For instance, electric vehicle 116 may unlock the first number and the second number of the plurality of cargo boxes (e.g., cargo boxes 112), which may be locked on chassis 114 and/or extendable chassis 302 with/using locking mechanisms 1002. Thus, all cargo boxes of cargo boxes 112 may be unlocked by electric vehicle 116 for a user/driver to unload the cargo boxes. For example, as described elsewhere herein, electric vehicle 116 may receive a signal from a user/driver to unlock cargo boxes 112. It is noted that block 1204 may unlock by a same or different method as block 1106 or block 1202.

In block 1206, subsequent to block 1204, the rear chassis is retracted from the extended configuration to the retracted configuration by the chassis motor. In an embodiment, electric vehicle 116 may be configured to retract extendable chassis 302 from extended configuration 300 to retracted configuration 100 using chassis motor 502. It is noted that electric vehicle 116 may be further configured to extend extendable chassis 302 from retracted configuration 100 to extended configuration 300. In a further embodiment, electric vehicle 116 may be configured to retract extendable chassis 302 from extended configuration 500 to retracted configuration 800 (e.g., by a linearly moving mechanism, a rotating mechanism, or a manual attachment method).

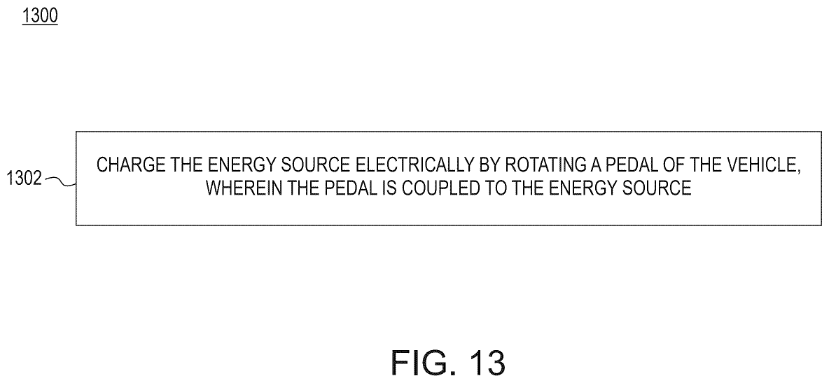

FIG. 13 depicts a flowchart 1300 for charging an energy source for the exemplary electric vehicle in accordance with one aspect of the present disclosure. The blocks of flowchart 1300 may be performed by a vehicle, such as an electric vehicle, and may follow one or more of the blocks in flowchart 1100 or flowchart 1200. Flowchart 1300 begins with block 1302, in which the energy source is charged electrically by rotating a pedal of the vehicle, wherein the pedal is coupled to the energy source. In an example, energy source 118 of electric vehicle 116 may be charged through pedal assist, in which a rotation of pedals 108 creates mechanical energy that may convert to electrical energy for energy source 118. Electricity is generated by energy source 118 as a result of energy source 118 being coupled to pedals 108. Rotation of pedals 108 may be induced by a user, such as a driver, of electric vehicle 116.

Through this pedal assist method, electric vehicle 116 may maintain a steady state of charge (SoC) while being driven by a user. Thus, minimal charge loss from energy source 118 may be achieved. For example, electric vehicle 116 may include a throttle or traditional pedal (as those found in gas-powered vehicles) for controlling the speed of the vehicle. The user may switch between using the throttle, traditional pedal, or pedals 108. Using the throttle or traditional pedal may cause the vehicle to lose charge from energy source 118, whereas using pedals 108 may cause the vehicle to maintain or increase charge to energy source 118.

It is noted that the flowchart blocks of FIG. 11, FIG. 12, and FIG. 13 need not be performed by an electric vehicle in the order described herein. Any order may be permissible. Furthermore, not all blocks may be required for an embodiment. Alternatively, additional blocks may be added for an embodiment.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but may be employed in any number of applications and equivalent devices by those of ordinary skill in the art. Rather it is hereby intended the scope of the disclosure be defined by the claims appended hereto.

What is claimed is:

1. A vehicle comprising:
one or more rear wheels and one or more front wheels;
a motor for rotating the one or more rear wheels;
an energy source powering the motor;
a pedal in combination with the motor for assisting in rotating the one or more rear wheels;
a rear chassis configured to carry a plurality of cargo boxes; and
a chassis motor coupled to the rear chassis for extending and retracting the rear chassis, wherein electrical wiring runs from the energy source and through the rear chassis to power the chassis motor.

2. The vehicle of claim 1, wherein the rear chassis comprises:
a fixed flatbed; and
a motorized flatbed configured to extend, from and parallel to, the fixed flatbed by the chassis motor.

3. The vehicle of claim 2, wherein the energy source is electrically recharged by a rotation of the pedal.

4. The vehicle of claim 2, wherein the rear chassis includes a plurality of locking mechanisms for coupling the plurality of cargo boxes to the rear chassis while the vehicle is in an extended configuration or a retracted configuration.

5. The vehicle of claim 4, wherein the plurality of locking mechanisms are located on the fixed flatbed and the motorized flatbed.

6. The vehicle of claim 1, wherein the energy source is mounted in a vertical orientation or a horizontal orientation near or between the one or more front wheels.

7. The vehicle of claim 6, wherein the energy source is removeable and replaceable by a second energy source.

8. The vehicle of claim 1, wherein the rear chassis comprises:
a fixed flatbed; and
a flatbed extension, wherein the fixed flatbed further includes a compartment internal to the fixed flatbed for storing the flatbed extension in a stored configuration.

9. The vehicle of claim 8, wherein the flatbed extension is attached to a coupling mechanism of the fixed flatbed while in the stored configuration.

10. The vehicle of claim 8, wherein the flatbed extension is not attached to a coupling mechanism of the fixed flatbed while in the stored configuration.

11. A method for transporting a plurality of cargo boxes through an electrically powered vehicle, the method comprising:
providing electrical power from an energy source of the vehicle to a chassis motor of the vehicle through electrical wiring that:
runs through a rear chassis of the vehicle; and
couples the chassis motor to the energy source of the vehicle;
extending the rear chassis from a retracted configuration to an extended configuration by the chassis motor, wherein the chassis motor is further coupled to an extendable portion of the rear chassis; and
locking a first number of the plurality of cargo boxes onto the rear chassis with respective locking mechanisms located on the rear chassis.

12. The method of claim 11, wherein extending the rear chassis from the retracted configuration to the extended configuration comprises:
extending the extendable portion of the rear chassis, from and parallel to, the retracted configuration of the rear chassis.

13. The method of claim 11, further comprising:
charging the energy source electrically by rotating a pedal of the vehicle, wherein the pedal is coupled to the energy source.

14. The method of claim 11, further comprising:
locking a second number of the plurality of cargo boxes onto the extendable portion of the rear chassis with respective locking mechanisms located on the extendable portion of the rear chassis.

15. The method of claim 14, further comprising:
unlocking the first number and the second number of the plurality of cargo boxes from the respective locking mechanisms.

16. The method of claim 15, further comprising:
retracting the rear chassis from the extended configuration to the retracted configuration by the chassis motor.

17. A cargo transportation system of an electrically powered vehicle, the system comprising:
one or more rear wheels and one or more front wheels;
an energy source mounted near or between the one or more front wheels and configured to power a motor that rotates the one or more rear wheels;
a pedal in combination with the motor for assisting in rotating the one or more rear wheels;
a rear chassis configured to carry a plurality of cargo boxes that is extendable past the one or more rear wheels; and
a chassis motor coupled to the rear chassis for extending and retracting the rear chassis, wherein electrical wiring runs from the energy source and through the rear chassis to power the chassis motor.

18. The system of claim 17, wherein the rear chassis comprises:
a fixed flatbed; and
a motorized flatbed configured to extend, from and parallel to, the fixed flatbed by the chassis motor.

19. The system of claim 18, wherein the energy source is electrically recharged by a rotation of the pedal.

20. The system of claim 17, wherein the rear chassis comprises:
a fixed flatbed including a coupling mechanism; and
a flatbed extension, wherein the fixed flatbed further includes a compartment internal to the fixed flatbed for storing the flatbed extension in a stored configuration.
